(19) United States
(12) Patent Application Publication
(10) Pub. No.: US 2006/0213335 A1
(43) Pub. Date: Sep. 28, 2006

(54) Ratchet wrench having rotatable rings for operating engaging member

(76) Inventor: Chih-Ching Hsieh, Taichung City (TW)

Correspondence Address: Chih-Ching Hsieh, 235 Chung - Ho, Box 8-24, Taipei, TW

(21) Appl. No.: 11/443,417

(22) Filed: May 31, 2006

Related U.S. Application Data
(63) Continuation-in-part of application No. 10/224,513, filed on Aug. 21, 2002, now abandoned.

(51) Int. Cl. B25B 13/46

(52) U.S. Cl. 81/63.1; 81/125

(57) ABSTRACT

A ratchet tool comprises a head having a hole and a ratchet mechanism received in an inner periphery of the hole, an engaging member rotatably engaged with the hole and the ratchet mechanism, and a first ring connected to a side of the engaging member and located above a surface of the head; a periphery of the first ring exceeding a periphery of the head; the first ring including a flange extending inwards from an inner periphery of the first ring; a textured surface is formed on an outer surface of the first ring; and a second ring connected to another side of the engaging member. The ring and the engaging member are formed as a one-piece member.

The invention is a continuation in part (CIP) of the U.S. patent application Ser. No. 10/224,513 filed at Aug. 21, 2002, invented and assigned to the inventor of the present invention, and thus the contents of the U.S. patent application Ser. No. 10/224,513 is incorporated into the present invention as a part of the specification.

### FIELD OF THE INVENTION

The present invention is relates to a ratchet wrench that has a ring connected to the engaging member which is rotated by manually rotating the ring so as to remove a loosened nut without touching the nut by hands of the user.

### BACKGROUND OF THE INVENTION

A conventional ratchet wrench generally includes a head with a ratchet mechanism received in an inner periphery of the hole in the head, an engaging member with teeth is engaged with the ratchet mechanism so as to be rotated by rotating the ratchet wrench. The ratchet mechanism allows the wrench to be rotated reciprocally without removing the tool from the object to be tightened or loosened. The object such as a nut can be loosened by rotating the wrench continuously. However, it is experienced that when the nut is loosened, the engagement between the head and the nut is not secured and the nut could be disengaged from the head of the wrench. Therefore, after the nut is loosened, the user rotates the nut by his or her finger and this is more efficient and convenient to take the nut from the threaded rod to which the nut is mounted. Nevertheless, the some situations, the nut is attached with grease, toxic or chemical substance that the user does not want to touch, or the nut is hot that could burn the user's fingers. Therefore, to develop a suitable wrench that removes the nut from a threaded rod easily is one of the goals that the applicant wants to achieve.

The present invention intends to provide ratchet wrench wherein the engaging member can be rotated by a ring connected thereto so that the nut can be rotated simply by rotating the ring.

### SUMMARY OF THE INVENTION

In accordance with one aspect of the present invention, there is provided a ratchet tool. The ratchet tool comprises a head having a hole and a ratchet mechanism received in an inner periphery of the hole, an engaging member rotatably engaged with the hole and the ratchet mechanism, and a first ring connected to a side of the engaging member and located above a surface of the head; a periphery of the first ring exceeding a periphery of the head; the first ring including a flange extending inwards from an inner periphery of the first ring; a textured surface is formed on an outer surface of the first ring; and a second ring connected to another side of the engaging member. The ring and the engaging member are formed as a one-piece member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the engaging member, the ring and the ratchet tool wrench of the present invention;

FIG. 2 is a perspective view to show the ratchet tool wrench of the present invention;

FIG. 3 is a cross section view to show the engagement of the ring and the engaging member;

FIG. 4 shows a nut is engaged with the engaging member of the ratchet tool wrench of the present invention;

FIG. 5 shows that the engaging member and the nut are rotated by rotating the ring;

FIG. 6 shows that the ring and the engaging member are made as a one-piece member;

FIG. 7 to 10 show different patterns of textured surface of the ring of the present invention;

FIG. 11 shows the ring has a flange;

FIG. 12 shows that the nut can be supported by the flange of the ring;

FIG. 13 shows that two rings are connected to two sides of the engaging member; and

FIG. 14 is a perspective view to show the ratchet wrench that has two rings on two sides of the engaging member.

### DETAILED DESCRIPTION OF THE PREFERRED EMBODIMENT

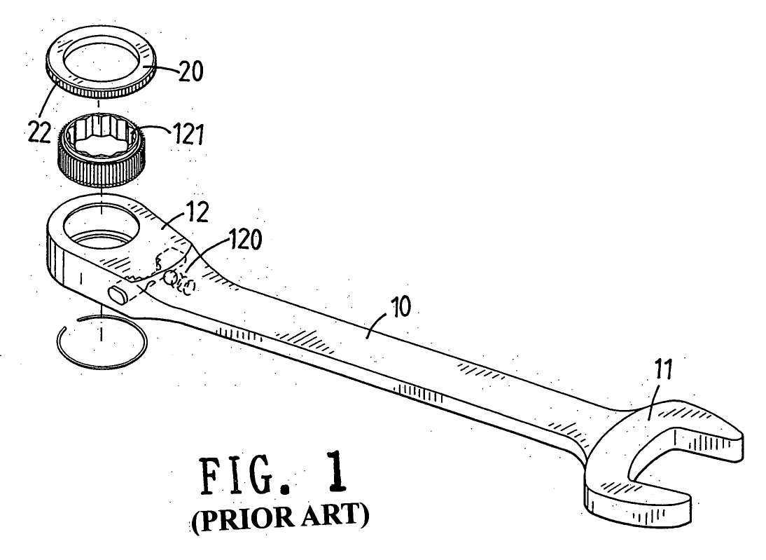

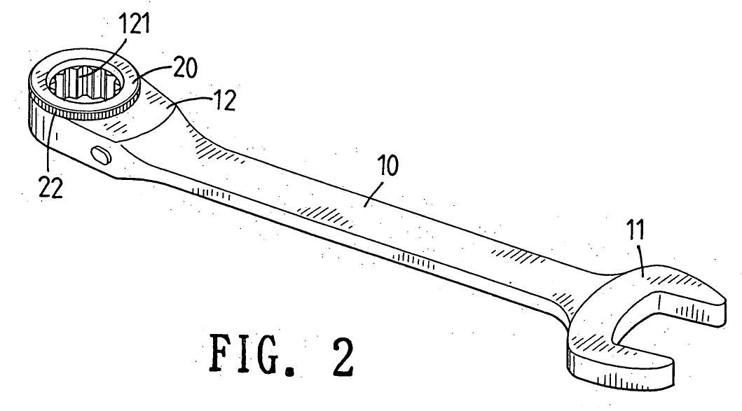

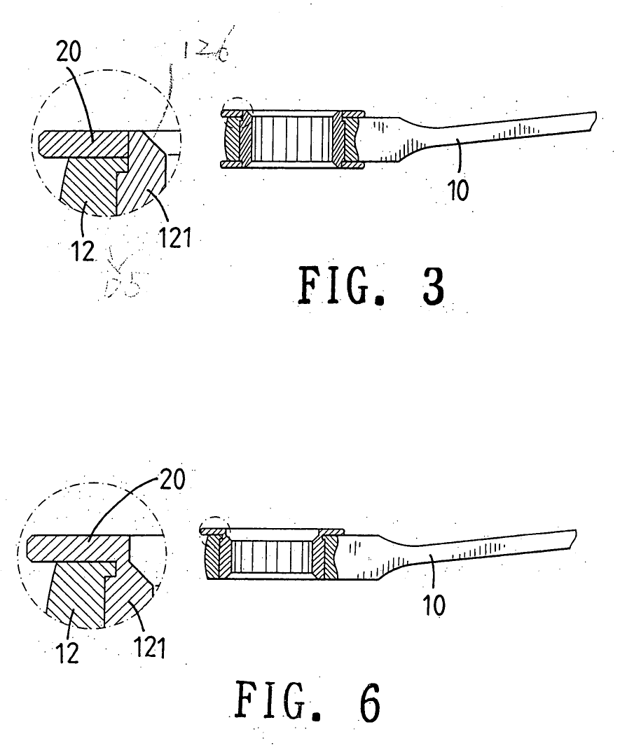

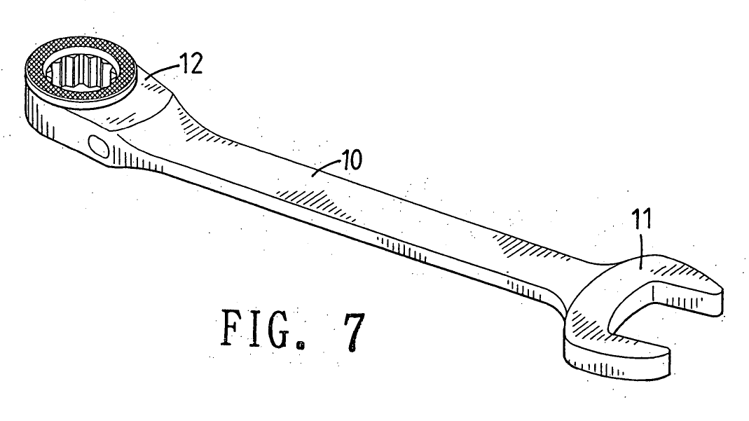

Referring to FIGS. 1 to 4 and 7, the ratchet tool 10 of the present invention comprises a box ended head 12 on one end thereof and an open ended function end on the other end thereof. The box ended head 12 has a hole and a ratchet mechanism 120 is received in an inner periphery of the hole. An engaging member 121 is rotatably engaged with the hole and the ratchet mechanism 120. Referring to FIG. 3, a middle section of an outer of the engaging member 121 is protruded out so that it is wider than an upper end and a lower end of the engaging member 121. The outer middle section of the engaging member 121 has a toothed outer periphery for being engaged with a pawl in the ratchet mechanism, and a polygonal inner periphery for being connected with a nut 2, for example. Furthermore, each of two ends of the inner surface of the engaging member 121 is chamfered to be as an inclined surface 126. Accordingly, the engaging member 121 can be rotated with the rotation of the ratchet tool 10 to tighten or loosen the nut 21, or can be rotate independently relative to the ratchet tool 10. A ring 20 is connected to a side of the engaging member 121 and located above a surface of the head 12. The ring 20 can be accessed by the user's hand and rotated to drive the engaging member 121.

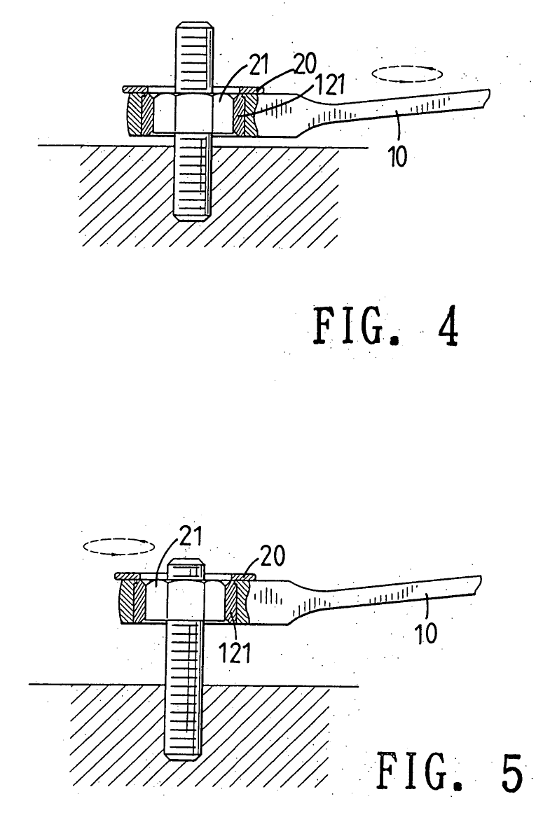

As shown in FIG. 4, after the nut 21 is loosened by rotating the tool 10, there is less torque required to continue to rotate the nut 20, the user may rotate the ring 20 as shown in FIG. 5 to rotate the engaging member 121 and the nut 21 without touching the nut 21 and rotating the tool 10. This is convenient for the user to remove the nut 21 in certain circumstance. In FIG. 3, the ring 20 and the engaging member 121 are discrete members instead of integral members. As shown in FIG. 6, the ring 20 and the engaging member 121 may be made as a one-piece member.

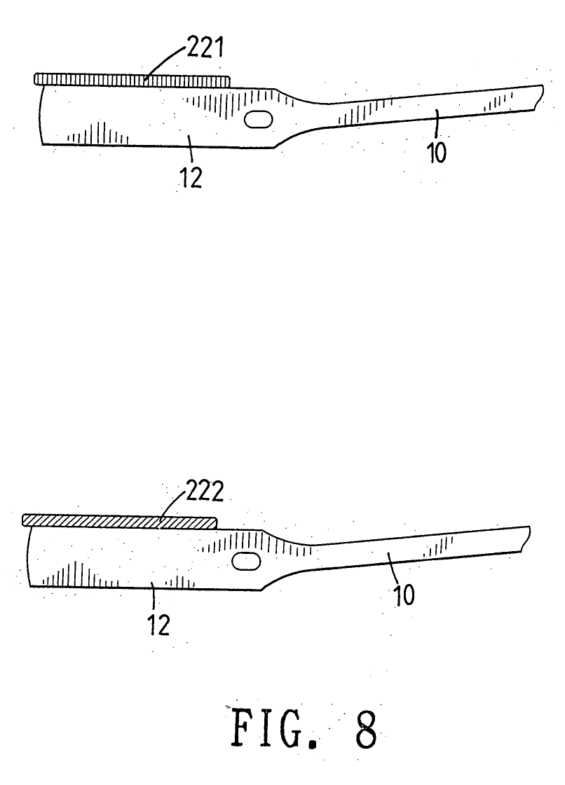

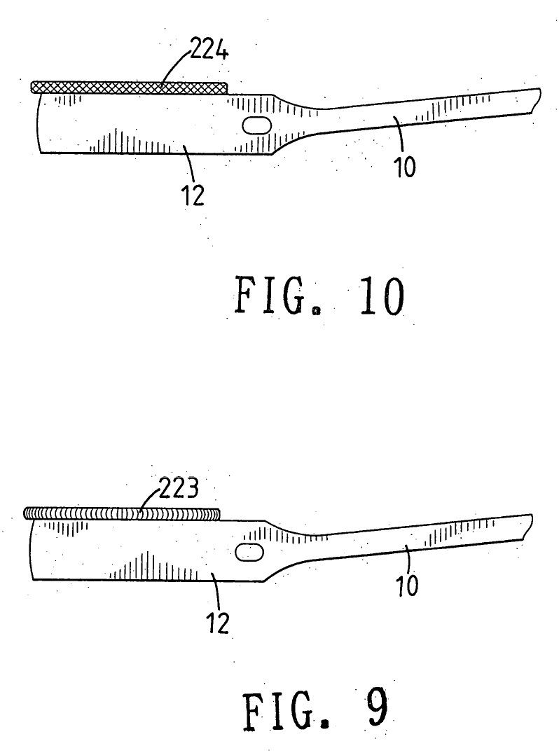

In order to increase the friction connected the ring 20 and the user's fingers, a textured surface 22 defined in an outer surface of the ring 20. The textured surface may have different patterns. For example, the textures of the textured surface is a plurality of strips 221 with each strip being vertical to one edge of the ring, see FIG. 8. Furthermore, the textures of the textured surface may be a plurality of strips 222 with each strip being sloped to one edge of the ring; or the textures of the textured surface is a plurality of intersect strips 224 as illustrated in FIG. 10; or the textures of the textured surface is a plurality of cambered strips 223, see FIG. 9.

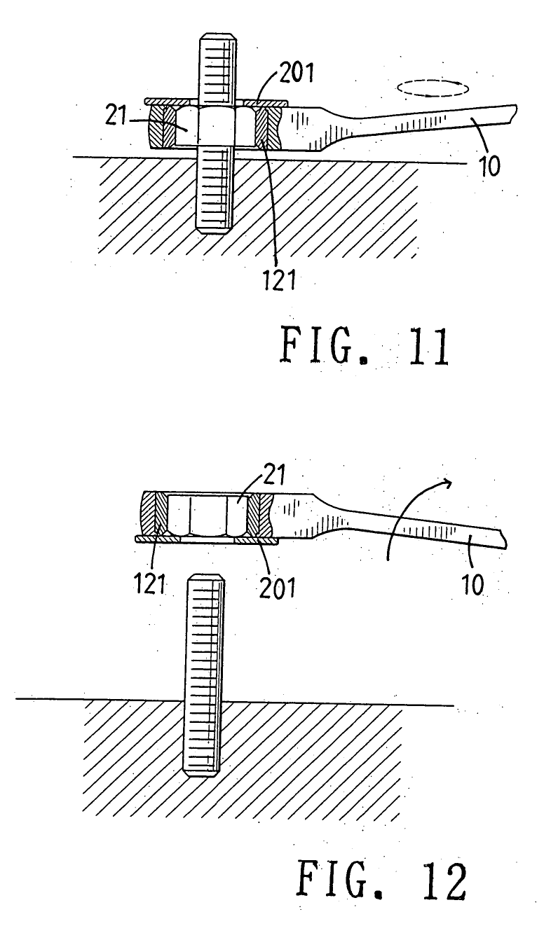

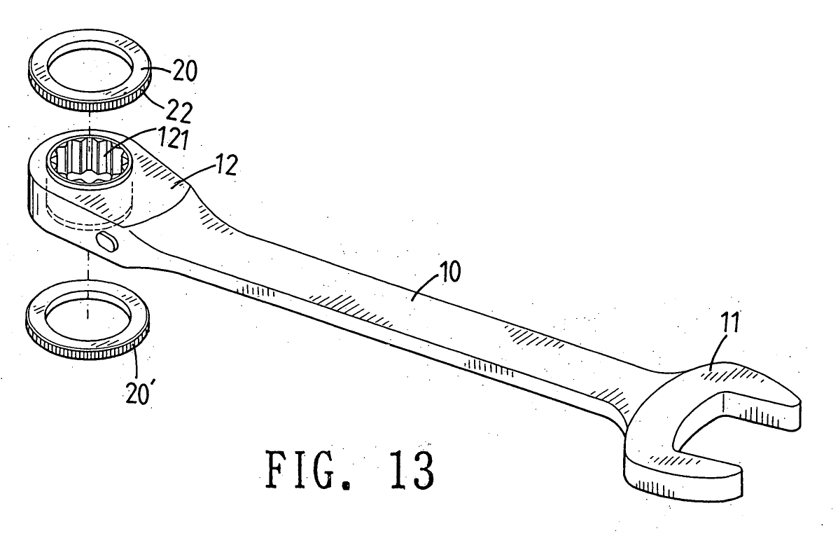

With reference to FIGS. 11 and 12, the ring 20 includes a flange 201 extends inward from an inner periphery thereof and the flange 201 supports the nut 21 when reversing the tool 10 to keep the nut 21 being received in the engaging member 121. By this way, the user dose not need to touch the nut 21 if the nut 21 has a high temperature or toxic material on it.

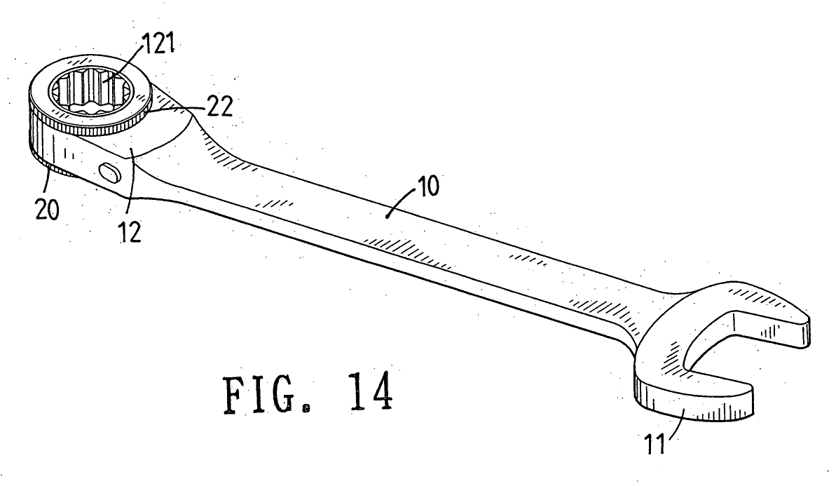

FIGS. 13 and 14 show that another ring 20′ is connected to the other side of the engaging member 121. Those identical to the above mentioned elements are numerated with the same numerals. It is illustrated that a ratchet tool comprises a head 12 having a hole and a ratchet mechanism 120 received in an inner periphery of the hole. The head has a groove and the groove has an upper opening and a lower opening. The head has an upper surface around the upper opening of the groove and a lower surface around the lower opening of the groove. An engaging member 121 is located within the groove and rotatably engaged with the ratchet mechanism in the hole, and a first ring 20 connected to an upper side of the engaging member 121 and located above the upper surface of the head 12. The size of the first ring is greater than that of the upper opening. A first textured surface 22 is formed on an outer surface of the first ring. A second ring 20′ is connected to a lower side of the engaging member; and located below the lower surface of the head 12. A size of the second ring 20′ is greater than that of the lower opening. A second textured surface is formed on an outer surface of the second ring. The first ring 20, the ratchet mechanism and the second ring 20′ are separated elements.

While we have shown end described the embodiment in accordance with the present invention, it should be clear to those skilled in that art that further embodiments may be made without departing from the scope of the present invention.

What is claimed is:

1. A ratchet tool comprising:
a head having a hole and a ratchet mechanism received in an inner periphery of the hole, the head having a groove and the groove having an upper opening and a lower opening; and the head having an upper surface around the upper opening of the groove and a lower surface around the lower opening of the groove;
an engaging member located within the groove and rotatably engaged with the ratchet mechanism in the hole, a middle section of an outer side of the engaging member being protruded out so that it is wider than an upper end and a lower end of the engaging member and thus the engaging member can be retained to the hole firmly; the outer middle section of the engaging member having a toothed outer periphery, and
a first ring connected to an upper side of the engaging member and located above the upper surface of the head; and a size of the first ring being greater than that of the upper opening;
a first textured surface being formed on an outer surface of the first ring;

2. The ratchet tool as claimed in claim 1, further comprising
a second ring connected to a lower side of the engaging member; and located below the lower surface of the head; and a size of the second ring being greater than that of the lower opening; and
a second textured surface being formed on an outer surface of the second ring.

3. The ratchet tool as claimed in claim 2, wherein the first ring, the ratchet mechanism and the second ring are discrete elements.

4. The ratchet tool as claimed in claim 2, wherein the first ring, the ratchet mechanism and the second ring are integral formed.

5. The ratchet tool as claimed in claim 1, wherein textures of the first textured surface are a plurality of strips with each strip being vertical to one edge of the first ring, respectively.

6. The ratchet tool as claimed in claim 2, wherein textures of the first and second textured surfaces are a plurality of strips with each strip being vertical to one edge of the first and second rings, respectively.

7. The ratchet tool as claimed in claim 1, wherein textures of the first textured surface are a plurality of strips with each strip being sloped to one edge of the first ring, respectively.

8. The ratchet tool as claimed in claim 2, wherein textures of the first and second textured surfaces are a plurality of strips with each strip being sloped to one edge of a respective one of the first and second rings, respectively.

9. The ratchet tool as claimed in claim 1, wherein textures of the first textured surface are a plurality of intersect strips.

10. The ratchet tool as claimed in claim 2, wherein textures of the first and second textured surface are a plurality of intersect strips.

11. The ratchet tool as claimed in claim 1, wherein textures of the first textured surface are a plurality of cambered strips.

12. The ratchet tool as claimed in claim 2, wherein textures of the first and second textured surfaces are a plurality of cambered strips.
